(19) United States
(12) Patent Application Publication
(10) Pub. No.: US 2008/0168247 A1
(43) Pub. Date: Jul. 10, 2008

(54) Method and apparatus for controlling access to a data storage device

(75) Inventors: William Preston Goodwill, Edmond, OK (US); Thomas John Schwartzkopf, Loveland, CO (US); Robert Harwell Thibadeau, Pittsburgh, PA (US)

Correspondence Address: PIETRAGALLO GORDON ALFANO BOSICK & RASPANTI, LLP, ONE OXFORD CENTRE, 38TH FLOOR, 301 GRANT STREET, PITTSBURGH, PA, 15219-6404, US

(73) Assignee: Seagate Technology LLC, Scotts Valley, CA (US)

(21) Appl. No.: 11/650,180

(22) Filed: Jan. 5, 2007

(51) Int. Cl. G06F 12/00

(52) U.S. Cl. 711/163; 711/E12.001

(57) ABSTRACT

An apparatus comprises a data storage device, and a security partition in the data storage device containing information defining a time period in which a user is authorized to access data stored in the data storage device. A method performed by the apparatus is also provided.

### FIELD OF THE INVENTION

This invention relates to data storage devices and more particularly to methods and apparatus for controlling access to data stored in the data storage devices.

### BACKGROUND OF THE INVENTION

Sensitive information stored on a data storage device, such as a disc drive, must be protected from unauthorized access. One particular security problem is that of prohibiting access to a data storage device during other than hours of operation allowed by established security policies. Employees who have been given access to data as part of their work assignments, but who in fact have the intent of gaining access to data for unauthorized purposes, might carry out certain types of attacks outside of normal business hours when the possibility of detection is reduced. Unauthorized persons who have gained access might also carry out these attacks during off-peak hours. Even on systems that limit access to those who have a valid security key or password, it would be desirable to further limit access by those users under certain conditions. It is common to find that machines are accidentally left on and logged in during off times, and it is common to find employees writing down passwords and putting them in places where they can be found.

There is a need for a method and apparatus that can restrict access to data in a data storage device to authorized users during authorized time periods.

### SUMMARY OF THE INVENTION

The invention provides an apparatus comprising a data storage device and a security partition in the data storage device containing information defining a time period in which a user is authorized to access data stored in the data storage device.

In another aspect, the invention provides a method comprising: configuring a storage media in the storage device to include a security partition containing information defining a time period in which a user is authorized to access data stored in the data storage device, and allowing user access to all or part of the data stored in the data storage device during the defined time period.

In yet another aspect, the invention provides an apparatus comprising a storage media including a security partition, and firmware for authenticating user access requests and for allowing user access to data stored on the storage media during a time period specified in the security partition.

### BRIEF DESCRIPTION OF THE DRAWINGS

FIG. 1 is an isometric view of a disc drive, which may include an embodiment of the present invention.

FIG. 2 is a block diagram of a computer system, which may include an embodiment of the present invention.

FIG. 3 is a more detailed block diagram of a computer system, which may include an embodiment of the present invention.

FIG. 4 depicts a block diagram of a system that can be constructed and operated in accordance with an embodiment of the present invention.

### DETAILED DESCRIPTION OF THE INVENTION

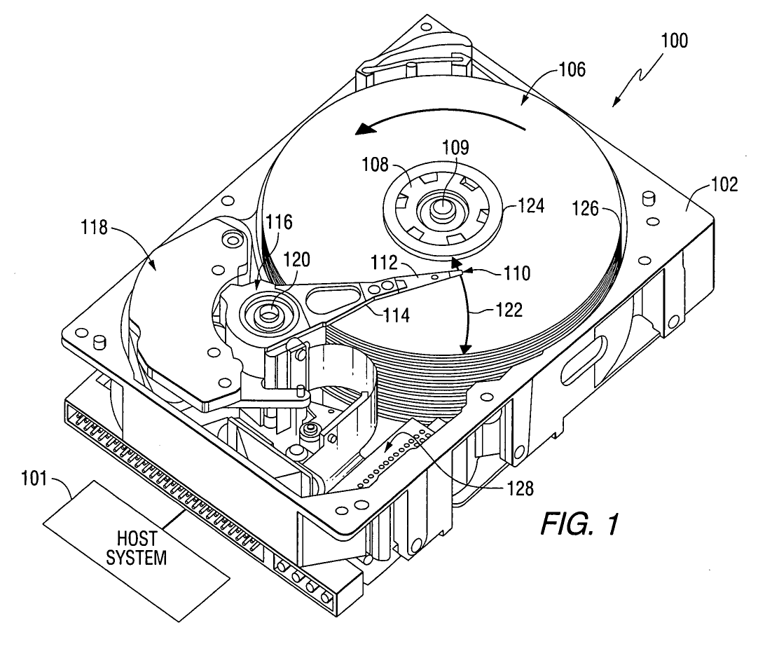

FIG. 1 is a perspective view of a system having a data storage device in the form of a disc drive 100 which may include an embodiment of the present invention. The data storage device 100 can be configured as a traditional magnetic disc drive, a magneto-optical disc drive, an optical disc drive, a probe storage device, or a flash memory, for example. Disc drive 100 includes a housing with a base 102 and a top cover (not shown). The disc drive 100 further includes a disc pack 106, which is mounted on a spindle motor (not shown) by a disc clamp 108. Disc pack 106 includes a plurality of individual discs 107, which are mounted for co-rotation about central axis 109. Each disc surface has an associated slider 110, which is mounted to disc drive 100 and carries a read/write head for communication with the disc surface.

In the example shown in FIG. 1, sliders 110 are supported by suspensions 112 which are in turn attached to track accessing arms 114 of an actuator 116. The actuator shown in FIG. 1 is of the type known as a rotary moving coil actuator and includes a voice coil motor (VCM), shown generally at 118. Voice coil motor 118 rotates actuator 116 with its attached sliders 110 about a pivot shaft 120 to position sliders 110 over a desired data track along a path 122 between a disc inner diameter 124 and a disc outer diameter 126. Voice coil motor 118 operates under control of internal circuitry 128. Other types of actuators can also be used, such as linear actuators.

Hereinafter, the terms “storage device” and “disc drive” are used interchangeably, except where otherwise noted, and include any data storage device that is accessible via a network or that is installed within, or can be connected to, a computer system. The storage device need not necessarily incorporate a physical disc, but preferably incorporates a data storage element for storing data, wherein data storage operations are managed by a controller with firmware.

As used herein, the phrase “computer system” is used to refer to any device having a storage device that can be used alone, or connected directly or indirectly to a private or public network. For example, computer systems include, but are not limited to, desktop computer systems, laptop computer systems, networked computer systems, wireless systems such as cellular phones and PDA's, digital cameras including self-contained web-cams, and/or any reasonable combination of these systems and devices.

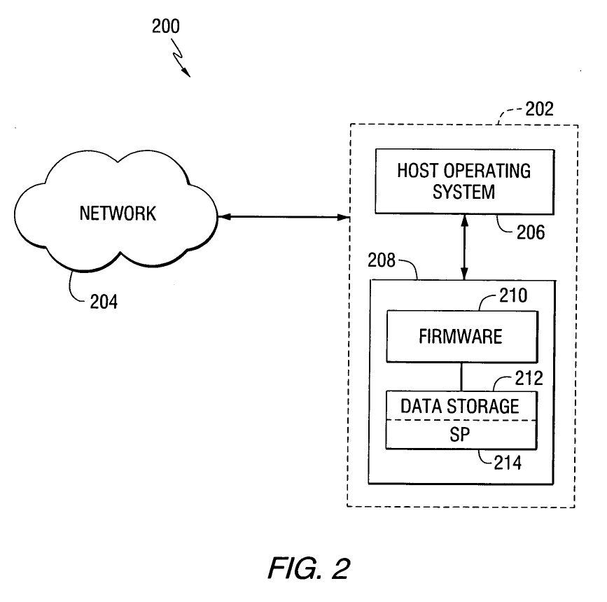

FIG. 2 illustrates a simplified block diagram of a system 200 including a security partition (SP) according to an embodiment of the present invention. As shown, the system 200 has a subsystem 202 in communication with a network 204. The network 204 can be of any type, including a local area network (LAN), wide area network (WAN), the Internet, ad hoc wireless network, public switched network, and so on.

The subsystem 202 includes a host operating system 206, which relies at least in part on software and data obtained from a storage device 208. Typically, the storage device 208 includes firmware 210 that reads and writes data to and from a data storage media 212 of the storage device 208.

In the example of FIG. 2, the storage media 212 includes a hidden partition 214 that includes one or more security partitions (SPs) or elements of the SPs required for access to data stored in the hidden partition and/or on the data storage media 212 of the storage device 208. Specifically, the SP may be used by the storage device 208 to control access to the storage device 208 as a whole, and to the data storage media 212. One SP may be utilized to manage one or more keys for one or more storage volumes. Data in an SP, including the keys, can optionally be encrypted using a different key. Security partitions are described in U.S. Pat. No. 7,036,020, the disclosure of which is hereby incorporated by reference.

In general, the partitions are a set of blocks in the storage media 212. The partitions can be hidden partitions, which are not acknowledged to the host operating system 206 because the hidden partition blocks are not addressed by read/write commands from the host. In other words, a hidden partition is hidden because the host operating system 206 is not aware that it exists except through commands specialized to the security features. Hidden space can be protected from whole volume encryption because no user command can write (or read) this space. The hidden partition 214 is not acknowledged to the operating system 206 of the host during the boot process.

The term “partition” is used in this example to mean a grouping of bytes allocated during low-level formatting of the storage device. In certain embodiments, a partition may refer to a grouping of memory blocks of approximately 512 bytes each. Special security partitions, and the structures and processes that support these security partitions, can be included in the computer system. Moreover, the operation of the present invention is substantially not dependent on the host operating system.

Generally, persistent data for a security partition (SP) is stored in a set of blocks in the storage media 212. In one embodiment, at least one set of blocks in the storage media 212 constitutes a hidden partition. The persistent data typically includes the name, passcode, and public-private keys for the SP and for authorized users of the SP. In other words, the SP stores its name and its passcode (i.e., the passcode the SP uses to authorize itself), and its public-private keys, as well as the names, passcodes and public keys of its permitted users. The persistent data can be stored in an authority table. An authority record is an entry in the authority table for a single user. This user may be a real person, another SP, a separate device, or any other entity capable of providing the proper credentials.

For the most part, an SP is a completely self-contained unit that manages its own access control. The SP also controls access to elements within the SP or accessible by the SP via firmware. The credentials needed for access in one example, include the name, the passcode, and the capability of proving identity (for example by digitally signing and directing information exchange with only the recipient). In establishing access controls for an SP, the creator can choose to allow access based on knowledge of the SP's name, of a passcode, and/or of private and public keys.

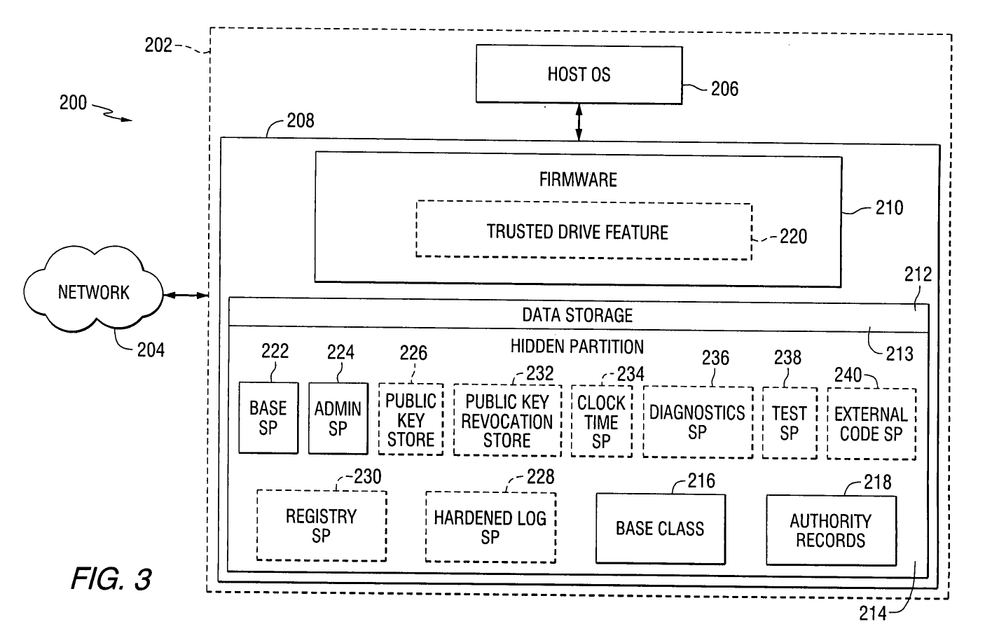

Referring to FIG. 3, the system 200 is shown as a simplified block diagram including a trusted drive feature. As shown, the system 200 has a subsystem 202 in communication with a network 204. The subsystem 202 includes a host operating system 206, which relies at least in part on software and data obtained from a storage device 208. Typically, the storage device 208 includes firmware 210 that controls reading and writing of data to and from the storage media 212. The storage media 212 is divided into a data portion 213 and a hidden portion (e.g., a hidden partition) 214. In this embodiment, a trusted drive feature 220 is embedded in the controller within the firmware 210.

Within the hidden partition 214, one or more authority records 218 and a base class 216 are stored. The authority records 218 can be used to access an SP or elements of an SP required for access to data stored in the hidden partition and/or on the data storage portion 212 of the storage device 208. In one example, all authority records 218 can be governed by a single master authority record. The host OS 206 is not permitted to access the SP data stored within the hidden partition 214, except through the trusted drive feature 220. This independence of the SP data from the host OS 206 provides an important benefit over conventional security methods and systems, namely that the hidden partition represents a location on a computer system where information, such as a secret, can be effectively concealed.

The hidden portion 214 of the storage device 208 has a base class 216, which can be used to specify a Base SP 222, from which all SP classes are ultimately derived. The base class 216 is sometimes referred to as a “root class”, and the Base SP is a “subclass” within a hierarchy of classes of the SP. Generally, the base class 216 allows the OEM or the manufacturer to specify a Base SP 222 from which each SP object can be instantiated and from which all other SP classes derive. The SP base class 216 provides default methods for an instantiated SP. For example, the SP base class 216 can provide default record data management methods and a default administration key, which can be used to log into the administration SP 224 and to configure access controls, which can override the default configuration. In other words, the administration SP 224 can be used to configure the access controls to disallow access using the default key and even to change access permissions for the administration SP 224.

The base class 216 also provides default methods for the secure import and export of entire SPs and parts of SPs, and for local replication of entire SPs within the storage controller based on triggers internal to the storage controller.

During manufacturing, the trusted drive is initialized with an administration SP 224 and a controller SP object, which in this embodiment is the trusted drive feature 220. The administration SP 224 provides access control for the creation, modification, and deletion of other SP objects.

Once the administration SP 224 is initialized, it is logged into, and the controller SP object is initialized with its own access controls. It is then possible to deny the administration SP 224 a right to further modify or destroy the controller SP.

As shown in FIG. 3, in addition to the Base SP 222 and the administration SP 224, other SP objects may be instantiated using the Base SP 222, including a public key store 226, a log SP 228, a registry SP 230, public key revocation store 232, a clock time SP 234, a diagnostics SP 236, a test SP 238, and an external code SP 240. Access to the administration SP 224 is required for the creation of other SPs.

The public key store 226 is used to cryptographically verify a request for a new SP instantiation. For example, in one embodiment, an SP object from the storage device manufacturer may require a digital signature associated with the storage device manufacturer in order to validate a request for a new SP instantiation.

In the embodiment of FIG. 3, the trusted drive 208 may also include a log SP 228 that can track and log the activity of other SPs based on the success or failure of the other SPs to gain access to data or to manipulate data. The log SP 228 can incorporate provisions for cyclic logs and other capabilities possible through the general access controls.

The Registry SP 230 type can provide a standard SP handle (e.g., virtual distinguished name) through which any number of physical copies of an SP object can be located and managed. The Registry SP 230 can distinguish and manage master SPs (both local and non-local), and can distinguish and manage specific Master data within an SP so that there can be a “Master Record” or “Master Value.”

The key and passcode revocation store 232 checks authorizing public keys, passcodes and other authentication elements for revocation. The clock time SP type 234 can provide a hardened source of clock or elapsed time both to other SPs and to the host.

A diagnostics SP 236 is adapted to provide hardened access control to storage controller diagnostics. A test SP 238 may be provided to harden control to storage controller testing as appropriate. Additionally, an external code SP 240 may be provided to harden access controls to customer provided software running on the storage controller.

Each of the above-described components may be implemented in a single trusted drive system 200 (as shown in FIG. 3). Alternatively, various SP elements 226-240 may be selected to be included as needed. The base class 216 is used to create each Base SP 222, and the Base SP 222 is used to create the SP objects for hardened security. In general, the storage location of the Base SP 222 and the various SP objects 224-240 may vary. Specifically, the SP objects 222-240 may all be stored outside of the hidden partition. However, if these objects are stored outside of the hidden partition, they must be encrypted to prevent access by system users.

It is possible to improve the security of files by limiting access to users who have a valid security key. The key would typically be stored in a protected area of a trusted disc drive in a security partition. The file itself would either be stored in a protected area of the disc drive or would be encrypted.

Constructs similar to smart cards that are stored on a trusted disc drive may be utilized in conjunction with encrypted files in order to limit access to a small number of users who have access to security keys. A smart card is an integrated chip security device capable of protecting data. An interface that uses smart card commands and data structures can be used to provide smart card functionality in a data storage device. Such commands and data structures can be compliant with a smart card standard, such as for example International Standard ISO-7816. The use of an interface with the functionality of traditional smart cards results in a virtual smart card. Thus virtual smart cards are a firmware and storage device embodiment of a smart card in an SP.

Virtual smart cards can be used to establish integrity, trust, and credentials for access to various information on the disc drive. More specifically, virtual smart cards are used to establish integrity, trust, and credentials that can be used for enabling and disabling the cryptographic functions in a storage device. Virtual smart cards can also provide keys and other secrets that can be used to provide various security operations in a data storage device. Multiple security partitions can be provided on a single storage device, with each security partition including virtual interfaces associated with a smart card.

This invention provides a method for controlling access to a data storage device by including a time window (or time period) for valid access to the information. The time window could occur once or multiple times, or it could be a repeating window that occurs, for example at a particular time of day.

A data center manager could set up the time window(s) defining a time period in which user activity is allowed on a file or set of files on a trusted disc drive. The time window(s) can be stored in cells in tables stored in the storage device.

This approach simplifies management oversight and control because a particular key can remain on the system even during times when access is not allowed, and this key can grant access during multiple, repeating time windows as desired. The invention could be included in any trusted disc drive. It makes use of several SPs and the drive trusted functionality. In an alternative embodiment, the time window(s) could be stored in a virtual smart card security partition.

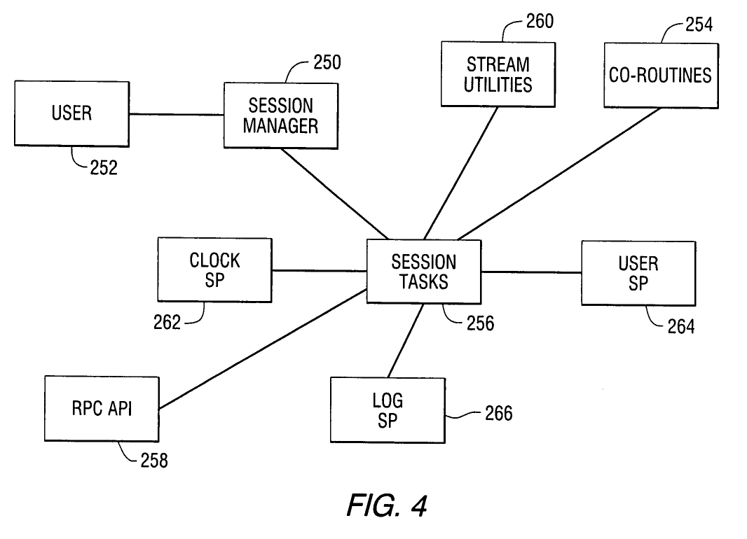

FIG. 4 depicts a block diagram of a system that can be constructed and operated in accordance with an embodiment of the invention. A Trusted Drive Session Manager 250 is implemented on the drive side and is responsible for managing all security session activity.

The user addressable storage space may be treated as a whole or divided for timed access. In one embodiment, the divisions may be ranges of logical block addresses. In another embodiment, the divisions may be logical objects that are addressed by ID numbers and byte offsets within the objects. Furthermore, the data in these divisions may be protected by the device simply blocking access or by an encryption of the data where the encryption key must be inserted or derived to gain access to the data. Furthermore, each division may individually be locked or blocked for reading or writing, or both. In a secure partition a table is kept of permitted begin and end times, and firmware in the device checks the clock time against the accepted ranges programmed in this table. Therefore, the device protects itself. In one embodiment the table may look like this:

| Division | | | | | | |
|---|---|---|---|---|---|---|
| ID | BeginTime | EndTime | Authority | EncryptKey | ReadLock | WriteLock |
| 1 | 8 AM | 5 PM | SystemAdmin | KeyReference_1 | Yes | Yes |
| | Weekdays | Weekdays | | | | |
| 2 | None | None | User | none | Yes | Yes |
| 3 | 8 AM | 5 PM | User | KeyReference_1 | Yes | Yes |
| | Weekdays | Weekdays | | | | |
| 4 | 9 AM | 11 AM | SystemAdmin | KeyReference_2 | Yes | No |
| | Weekdays | Weekdays | | | | |
| 4 | 1 PM | 5 PM | SystemAdmin | KeyReference_2 | Yes | No |
| | Weekdays | Weekdays | | | | |

For Division ID 1, the system administration authority may unlock this division for reading and writing between the hours of 8:00 a.m. to 5:00 p.m. on weekdays and this section of the storage is protected by encryption as well as locking. For Division ID 2, the user may unlock this division anytime and this division is not protected by encryption. For Division ID 3, the user may unlock this section between the hours of 8:00 a.m. to 5:00 p.m. on weekdays for reading and writing. For Division ID 4, the system administration authority may unlock this section for reading only and during the hours of 9:00 a.m. to 11:00 a.m. and 1:00 p.m. to 5:00 p.m. on weekdays.

Note that the user or system administration authority that is unlocking a division for reading or writing is not necessarily the same authority that has logged into the host. For example, the system administration authority may enable reading and writing of Division ID 1 for the currently logged in user, or disable it.

Changing the values in the time-locking table is subject to the proper authentication. For example, there may be a SystemAdmin authority that is the only authority that is privileged to change the division settings, times, authority settings, encryption settings, and locking settings.

The storage device may have its own trusted source of clock time or may have to receive it from a trusted source over the interface. If the device has its own trusted source of clock time, then this time becomes the time compared. If the device must receive a trusted time, then time setting must be properly authenticated as described elsewhere.

A user 252 submits session requests to the Session Manager 250, which authenticates the session requests and initiates co-routine tasks 254 in a Firmware Task Manager queue. The Session Manager is implemented in drive firmware and is responsible for managing all activity in each of several security sessions. The Session Manager 250 authenticates session requests and initiates co-routine tasks in a Firmware Task Manager queue (not shown). Another embodiment would be to have only a single session. Session requests are authenticated through a key exchange between the host and the Session Manager at the time the session is opened. Co-routines execute on different task threads and make use of a fairness policy to share CPU time among them all.

Once a task request gains priority, the Session Tasks module 256 must complete the parsing of the command payload for each Packet within the Trust Session functionality. A special data payload, having contents defined by the TCG, the Trusted Computing Group, is sent from the host to the drive via a transport command, wherein command codes are defined by the TCG T10 or T13 standards body. Within this payload is a “Superpacket”, consisting of one or more “Packets”, with each Packet consisting of one or more “Subpackets”. The format of this payload Superpacket is defined by the TCG. The Session Manager 250 parses the Superpacket and extracts the individual Packets. Each Packet is related to a single security “Trust Session”. Each Packet is in a byte stream buffer that is controlled by an individual Session Task 256, which operates on a separate thread.

For each Subpacket within the Packet, it is the responsibility of the Remote Procedure Call (RPC) module 258 to complete the parsing of the Subpacket containing the RPC call. This is done via a GetToken functionality combined with functions in the Stream Utilities module 260. Once the individual data values have been parsed, it can be determined whether the particular user request can be granted. The Packets are then parsed within an individual Session Task 256 to extract the Subpackets. Each Subpacket contains either an RPC command or a data token. RPCs are placed into the Subpacket by the host, and then this eventually results in a function on the drive being invoked, after being individually authorized. Data tokens are extracted from the stream using the GetToken functionality. Parsing is required to “break down” the data stream into the individual command and data components.

The drive has a clock SP 262 that handles all trusted clock activities on the drive such as setting the clock, reading the clock, updating the clock, and other functions. The actual time comes from a trusted source (e.g., the host). In a typical embodiment, no additional clock hardware is needed on the drive. The firmware simply counts ticks on an existing clock to keep track of time increases.

The data center manager creates a User SP 264 on the trusted drive that contains time intervals and an access key defined for a particular user. This action establishes the time window(s) during which user activity is allowed on a file or set of files on the trusted disc drive.

Time of day information can be established from the host computer at periodic intervals sufficient to maintain absolute timing accuracy on the trusted disc drive through the use of firmware alone. If this approach is used, a level of trust must be established between the host sending the time update and the drive accepting the time update.

Alternatively, the trusted disc drive hardware could be designed to maintain absolute real time for longer intervals, thus minimizing the need for frequent time updates from the host computer and helping to make the trusted drive less vulnerable to attacks. Another embodiment would add a hardware clock for more accurate timekeeping.

In one embodiment, the host computer is trusted to handle the action of validating the user access based on comparing the actual clock time to the time window set up in the User SP. In this scenario, the host application would fetch the time intervals from the User SP. It would read the actual clock time and make a comparison to determine if the user should be given access to a key that unlocks the contents of an encrypted file. If the time is within a specified interval, the host application would request that the trusted drive fetch the access key and decrypt the desired data with it. This process may be made more secure if the host has a trusted source of real time. The drive trusts the host as an accurate source of time, through an authentication process established by the TCG. The host must either be the primary time source, or must derive the absolute time from some other trusted source. In another embodiment, the host computer is not trusted to make the time comparisons. In this case, a script is sent from the host application to the trusted drive. The host also reads the actual clock time and sends it to the drive, unless the trusted drive has hardware to maintain the absolute real clock time internally. Within the drive, the permitted time intervals are fetched from the User SP. The drive firmware compares this time window to the actual clock time and determines whether the user should be given access to the contents of an encrypted file. If the time is within a specified interval, the trusted drive fetches the access key, decrypts the desired data with it, and sends it to the user.

The authorized time period may be implemented as a repeating time window each business day (or other interval) during which the protected data can be accessed, or it may be implemented as a single window of opportunity for access that spans portions of one or more business days.

A particular user may be granted an access time window that is independent of access time windows for any other users. Logging of authorized and unauthorized access attempts, in a Log SP 266, could include absolute time of day and date information.

While the invention has been described in terms of several embodiments, it will be apparent to those skilled in the art that various changes can be made to the described embodiments without departing from the scope of the invention as set forth in the following claims.

What is claimed is:

1. An apparatus comprising:
a data storage device; and
a security partition in the data storage device containing information defining a time period in which a user is authorized to access data stored in the data storage device.

2. The apparatus of claim 1, wherein the information defining a time period in which a user is authorized to access data stored in the data storage device is stored in a table in the security partition.

3. The apparatus of claim 1, wherein the time period is a repeating time period.

4. The apparatus of claim 1, further comprising:
a key stored in the data storage device and accessible only in the time period in which the user is authorized to access data stored in the data storage device.

5. The apparatus of claim 1, wherein the security user partition comprises a virtual smart card.

6. The apparatus of claim 1, further comprising:
a clock security partition in the data storage device.

7. The apparatus of claim 1, further comprising:
a clock in the data storage device.

8. A method comprising:
configuring a storage media in a storage device to include a security partition containing information defining a time period in which a user is authorized to access data stored in the data storage device; and
allowing user access to the data stored in the data storage device during the defined time period.

9. The method of claim 8, wherein the information defining a time period in which a user is authorized to access data stored in the data storage device is stored in a table in the security partition.

10. The method of claim 8, wherein the time period is a repeating time period.

11. The method of claim 8, wherein a key is stored in the data storage device and accessible only in the time period in which the user is authorized to access data stored in the data storage device.

12. The method of claim 8, wherein the security user partition comprises a virtual smart card.

13. The method of claim 8, further comprising:
a clock security partition in the data storage device.

14. The method of claim 8, further comprising:
a clock in the data storage device.

15. The method of claim 8, wherein user access is limited to one or both of: reading data and writing data.

16. The method of claim 8, wherein a session manager authenticates session requests from the user.

17. The method of claim 16, wherein session requests are authenticated through a key exchange between the session manager and a host.

18. The method of claim 8, wherein a host validates user access based on a comparison of actual clock time and the defined time period.

19. An apparatus comprising:
a storage media including a security partition; and
firmware for authenticating user access requests and for allowing user access to data stored on the storage media during a time period specified in the security partition.

20. The apparatus of claim 19, wherein the firmware checks a clock time against the time period specified in the security partition prior to authenticating user access.
